(19) United States
(12) Patent Application Publication
(10) Pub. No.: US 2010/0034271 A1
(43) Pub. Date: Feb. 11, 2010

(54) Method of and system for efficient macroblock partition searching using sub-macroblocks

(76) Inventors: Andrew Yang, Sunnyvale, CA (US); Mark Snesrud, Redwood City, CA (US)

Correspondence Address: INNOVATION MANAGEMENT SCIENCES, P. O. BOX 1169, LOS ALTOS, CA, 94023-1169, US

(21) Appl. No.: 12/221,709

(22) Filed: Aug. 5, 2008

(51) Int. Cl. H04N 7/26

(52) U.S. Cl. 375/240.16; 375/E07.075

(57) ABSTRACT

A method, system and computer program product for motion search of a video frame is provided. Sub-macroblocks are used as basic unit for motion search. The comparison results are saved and the saved results can be used to compute best matches for larger partition sizes. A patterned search is also used so as to improve the performance of the motion search.

### FIELD OF THE INVENTION

The present invention relates generally to digital video signal processing, and more specifically to devices for video coding.

### BACKGROUND OF THE INVENTION

Video coding standards that make use of several advanced video coding tools and techniques to provide high compression performance are well known in the art. In the past, standards such as MPEG-2, MPEG4, and H.263 have been widely adopted. More recently, H.264 has been widely adopted as it offers better compression performance than other video compression standards. At the core of all these video compression standards are the techniques of motion compensation and transform coding.

Motion compensation schemes basically assume, for most sequences of video frames, the amount of change from one frame to the next is small. Thus, compression can be achieved by transmitting or storing information in a frame as a difference, or delta, from a previous frame, rather than as an independent image. In this way, only the changes between a new frame and a previous frame need to be captured. The frame used for comparison is called a reference frame. The frame that is being encoded is called a current frame.

The specific type of motion compensation schemes used by many video encoding standards, such as H.264 AVC, is called block motion compensation. Block motion compensation schemes typically decompose a frame into macroblocks where each macroblock contains 16×16 luminance values (Y) and two 8×8 chrominance values (Cb and Cr), although other block sizes are also used. These macroblocks are typically processed one at a time. The compression mechanism in a video encoder would attempt to find a macroblock in the reference frame that closely matches the current macroblock of the current frame (motion estimation), and the differences between these two blocks would be transformed and quantized. The transform of a macroblock converts the pixel values of the block from the spatial domain into a frequency domain for quantization. This transformation step may use a two-dimensional discrete cosine transform (DCT) or other transformation methods. The residual macroblock data generated by the transformation step is then quantized, and then coded by using variable length coding.

During motion estimation, the video encoder would attempt to find a macroblock in the reference frame that best matches the current macroblock of the current frame by comparing the current macroblock against macroblocks in the reference frame. The best match is determined for instance by choosing the macroblock with the lowest SAD (Sum of Absolute Differences). In a typical implementation, in order to find the best match, a search area of the reference frame may be stepped through one pixel at a time. Thus, even for a small search area, many comparisons are necessary. A “search” herein refers to the process of determining a best match (e.g., a macroblock in a predetermined search area of a reference frame) for a current macroblock.

FIG. 1 depicts a motion search that is typically implemented in a video encoder integrated circuit. As shown, a current macroblock 102 is compared against macroblocks of a reference frame 104, including macroblocks 106a-106c. The macroblock data is stored “off-chip” in a frame memory, which may be implemented by DRAM due to the number and size of the frames. The macroblocks 106a-106c are retrieved one macroblock at at a time from the frame memory. The SAD values generated by these comparisons are compared against each other to produce a best-match. As illustrated, the macroblocks 106a-106c may overlap each other and other macroblocks.

High-resolution frames have a large number of macroblocks and thus require a large number of searches performed per frame. Since each search requires comparison of the current macroblock against many reference macroblocks, which are stored in the frame memory, a large amount of macroblock data would have to be moved from the frame memory to the encoder per frame. If the encoder is designed for real-time encoding of video data, which may require numerous frames per second, an even higher memory throughput would be needed. Such a high memory throughput is difficult to achieve, particularly in a compact encoder design suitable for mobile devices where there may not be sufficient room for routing data paths and where power consumption is a important design constraint.

Accordingly, what is desired is a method and system for motion estimation that is highly efficient in terms of memory throughput.

### SUMMARY

A method and system for motion estimation that is highly efficient in terms of memory throughput is provided. Sub-macroblocks are used as basic unit for motion search. The comparison results are saved and the saved results can be used to compute best matches for larger partition sizes.

According to an embodiment of the invention, a 16×16 macroblock is sub-divided into a group of four quadrants of 8×8 sub-macroblocks. Motion searches are accomplished by stepping the current macroblock through the macroblocks in a search area of the reference frame row-by-row with no overlap. Each quadrant of the reference sub-macroblock is compared against all four quadrants of the current macroblock to produce four sub-macroblock Sum of Absolute Difference (SAD) values. The sub-macroblock SAD values are temporarily stored and selectively summed to produce one or more macroblock-level SAD values. When all the macroblocks of the search area have been scanned, the resulting SAD values are compared to generate the best match macroblock.

### BRIEF DESCRIPTION OF THE DRAWINGS

The invention will now be described with reference to the accompanying drawings, which are provided to illustrate various example embodiments of the invention. Throughout the description, similar reference names may be used to identify similar elements.

FIG. 1 depicts a motion search that is typically implemented in a video encoder integrated circuit;

FIG. 2 depicts a motion search that is implemented according to an embodiment of the invention;

FIGS. 3A-3E depict the macroblock-level SAD values that can be generated using the sub-macroblock SAD values according to an embodiment of the invention;

FIG. 4 depicts a motion search that is implemented according to a preferred embodiment of the invention;

FIG. 5A depicts the SAD values generated when two macroblocks have been processed according to an embodiment of the invention;

FIGS. 5B-5F depict the macroblock-level SAD values that can be generated using sub-macroblock SAD values according to a preferred embodiment of the invention; and

FIG. 6 depicts a block diagram for a portion of a video encoder including a SAD calculation unit according to an embodiment of the present invention.

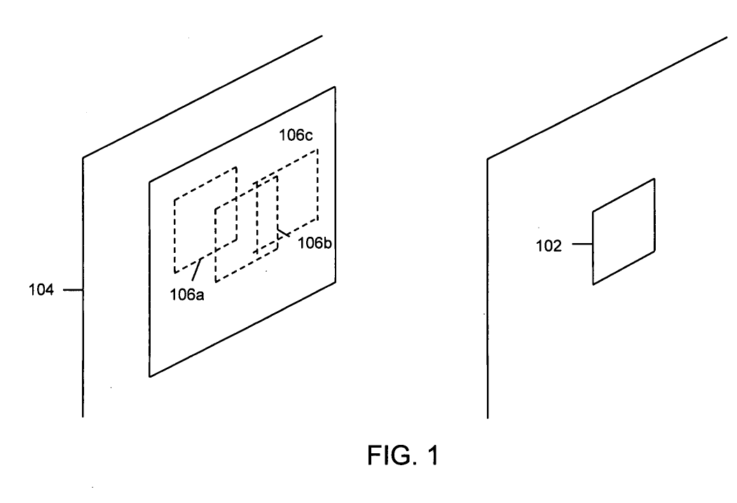

### DESCRIPTION OF VARIOUS EMBODIMENTS

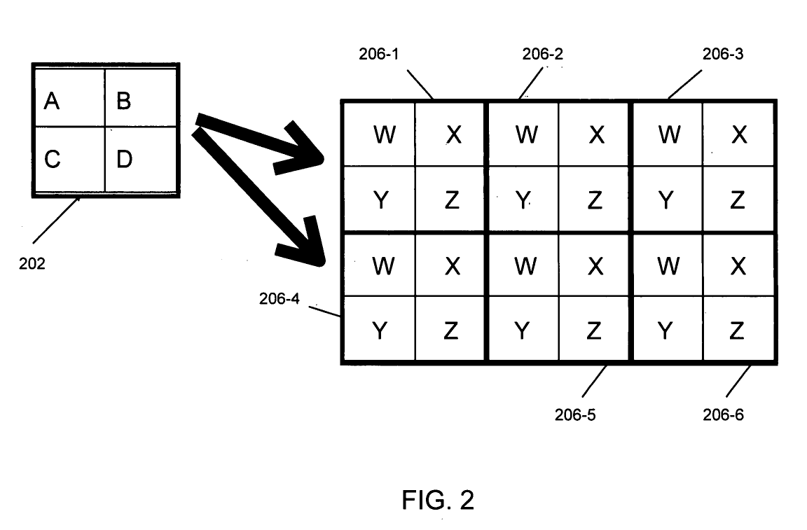

The present invention provides a method and system for motion search that is highly efficient in terms of memory throughput. FIG. 2 depicts a motion search that is implemented according to an embodiment of the invention. As shown, current macroblock 202 is compared against macroblocks 206-1 to 206-6 of a reference frame. Note that there is no overlapping among the macroblocks 206-1 to 206-6. Furthermore, according to an embodiment of the invention, the current macroblock and the macroblocks 206-1 to 206-6 are each sub-divided into four 8×8 sub-macroblocks.

The macroblocks 206-1 to 206-6 may be retrieved one macroblock at a time, row-by-row, from the frame memory (not illustrated) where the macroblock data is stored. Values for determining best match (e.g., SAD values) are determined for each sub-macroblock and stored by the video encoder integrated circuit. More specifically, sub-block A of macroblock 202 is compared against sub-block A of macroblock 206-1 to produce a first sub-macroblock SAD value S_{AW1}, and sub-block B of macroblock 202 is compared against sub-block B of macroblock 206-1 to produce a second sub-macroblock SAD value S_{BX1}, etc. This process is repeated for each of the macroblocks 206-2 to 206-6 to generate a set of sub-macroblock SAD values 300. In an implementation of the present invention, the set of sub-macroblock level SAD values 300 are stored in the video encoder integrated circuit until at least after a next row of macroblocks in the same row has been processed. For instance, sub-macroblock SAD values for macroblocks 206-1 to 206-3 stored locally within the video encoder integrated circuit until at least after sub-macroblock SAD values for macroblock 206-4 to 206-6 have been calculated.

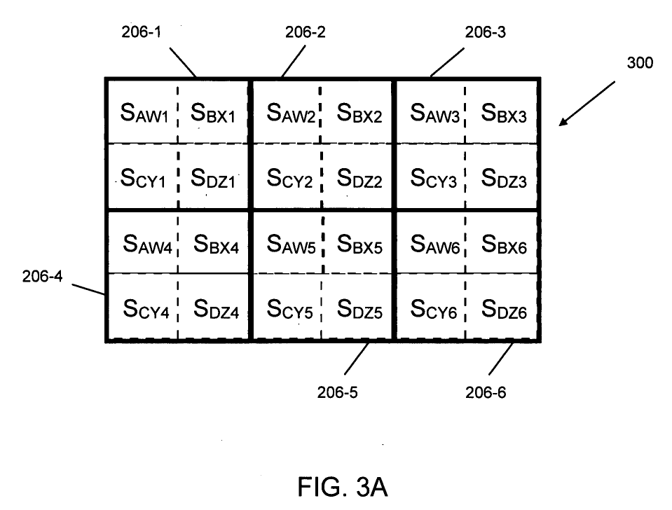

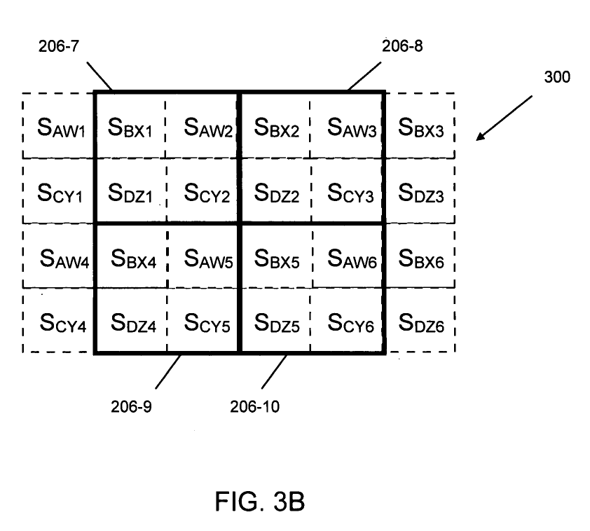

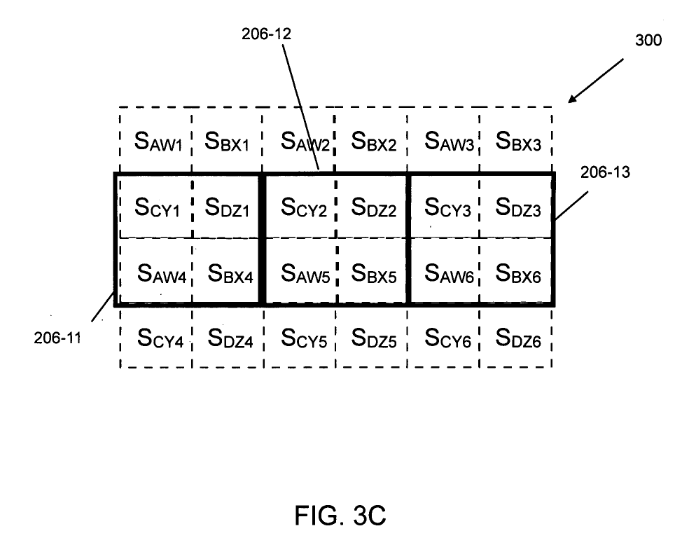

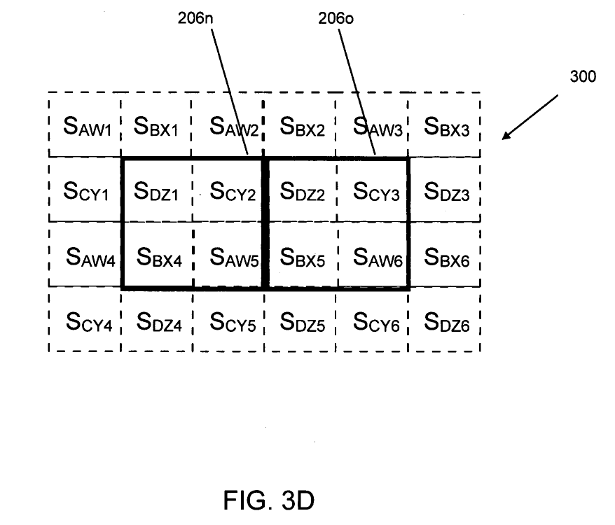

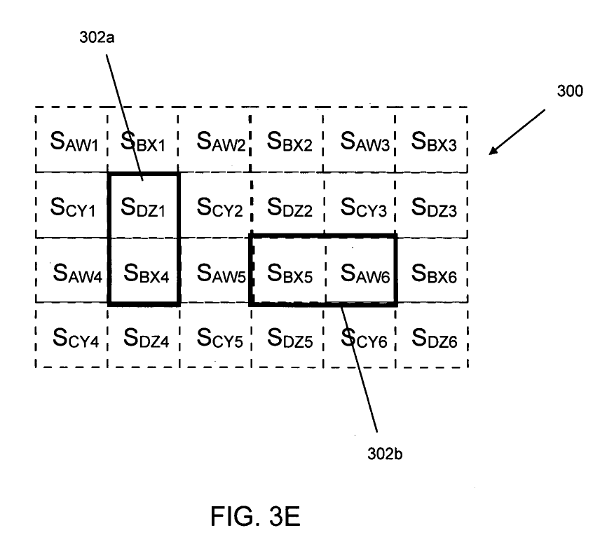

Once the set of sub-macroblock SAD values 300 are calculated, macroblock-level SAD values can be easily generated by summing appropriate sub-macroblock SAD values. FIG. 3A depicts the macroblock-level SAD values that can be generated by using the set of sub-macroblock SAD values 300. As illustrated, sub-macroblock SAD values S_{AW1}, S_{BX1}, S_{CY1}, S_{DZ1} can be combined to produce macroblock-level SAD values for macroblock 206-1. Macroblock-level SAD values for macroblocks 206-2 to 206-6 can be similarly computed.

FIG. 3B depicts other macroblock-level SAD values that can be generated by using the set of sub-macroblock SAD values 300. As illustrated, the sub-macroblock SAD values S_{BX1}, S_{DZ1}, S_{AW2}, S_{CY2} can be used to produce SAD value for macroblocks 206-7 (shown superimposing on the set of sub-macroblock SAD values 300). Similarly, SAD values for macroblocks 206-8 to 206-10 can be computed by using the appropriate sub-macroblock SAD values 300.

FIG. 3C depicts yet other macroblock-level SAD values that can be generated by using the same set of sub-macroblock SAD values 300. As shown, the sub-macroblock SAD values S_{CY1}, S_{DZ1}, S_{AW4}, S_{BX4} can be used to produce SAD values for macroblocks 206-11. Similarly, SAD values for macroblocks 206-12 to 206-13 can be computed by using the appropriate sub-macroblock:SAD values 300. FIG. 3D depicts yet other macroblock-level SAD values that can be generated by using the same set of sub-macroblock SAD values 300. As shown, the sub-macroblock SAD values S_{DZ1}, S_{CY2}, S_{BX4}, S_{AW5} can be used to produce SAD values for macroblocks 206-14. Similarly, SAD values for macroblock 206-15 can be computed by using the appropriate sub-macroblock SAD values 300.

In FIGS. 3A-3D, a total of fifteen macroblock-level SAD values can be calculated from the same sub-macroblock SAD values. Note that, in accordance with the present embodiment, data corresponding to merely six macroblocks (e.g., macroblocks 206-1 to 206-6) have been retrieved from the frame memory. Thus, using the technique of the present invention, the number of frame memory accesses for motion search is significantly reduced. The increase in the complexity of the logic that implements the sub-macroblock level comparison is minimal and a small amount of local memory would be required to store the sub-macroblock SAD values locally in the encoder integrated circuit.

With reference now to FIG. 3E, macroblocks of different sizes, such as 8×16, can be searched using the same set of sub-macroblock SAD values 300 in accordance with an embodiment of the invention. As shown in FIG. 3E, SAD values for macroblock 302a can be generated by summing the SAD values S_{DZ1} and S_{BX4}. Similarly, SAD values for macroblock 302b can be generated using appropriate ones of the sub-macroblock SAD values 300.

Attention is directed now to a preferred embodiment of the present invention. According to this embodiment of the invention, motion search is accomplished by stepping a current macroblock through the macroblocks in a search area of the reference frame row-by-row with no overlap. Each sub-macroblock (e.g., A, B, C, D) of a current macroblock is compared against each sub-macroblock (e.g., W1, X1, Y1, Z1) of the reference frame. For example, macroblocks 406-1, 406-2 and 406-3 of row 402 are retrieved from the frame memory one macroblock at a time, starting with macroblock 406-1. When all the macroblocks of row 402 have been processed, macroblocks 4064, 406-5, and 406-6 of row 403 are retrieved and processed.

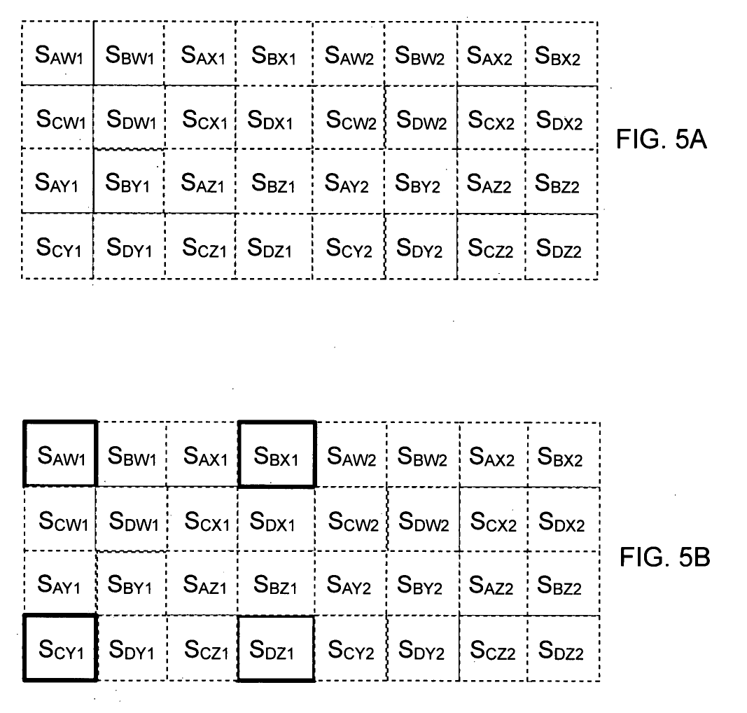

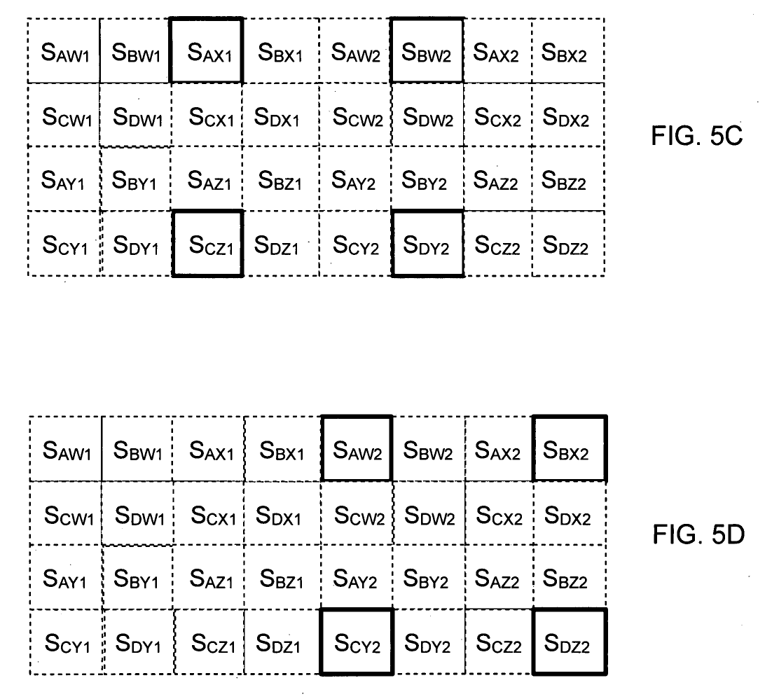

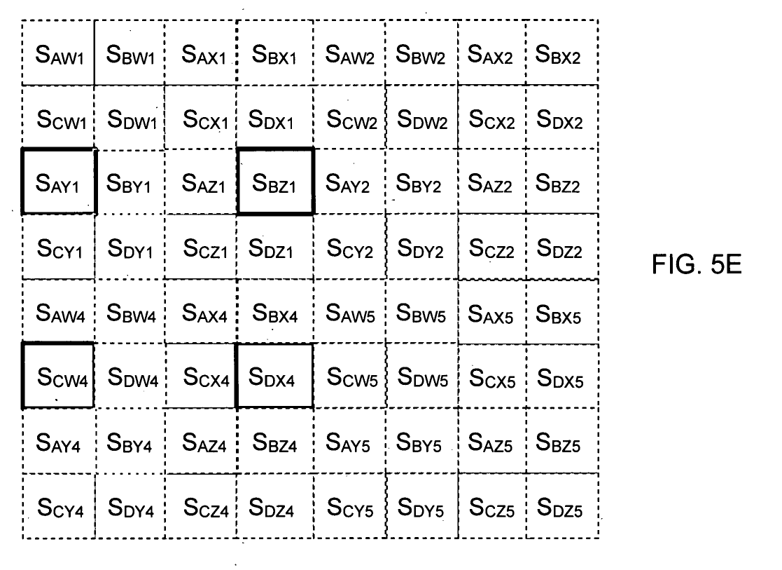

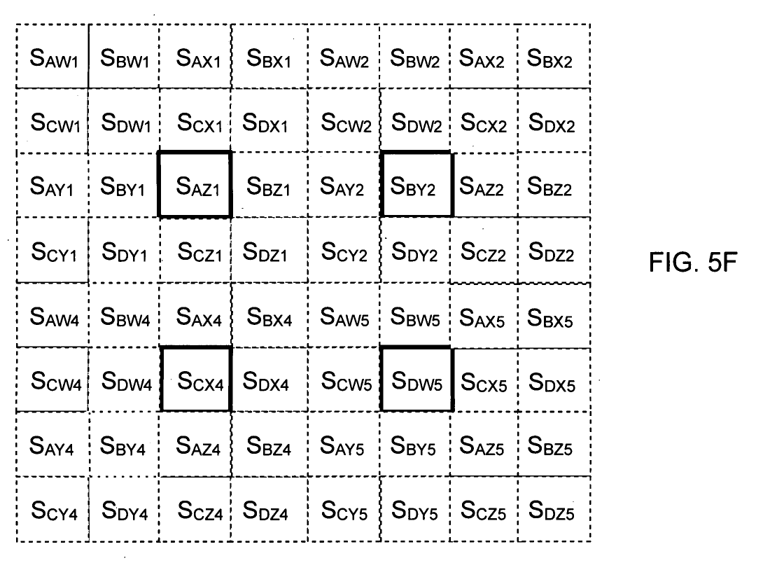

FIG. 5A depicts the SAD values generated when two macroblocks 406-1 and 406-2 have been processed according to an embodiment of the invention, where S_{AW1} denotes the SAD value generated by comparing sub-block A and sub-block W1 of macroblock 406-1, and S_{CY2} denotes the SAD value generated by comparing sub-block C and sub-block Y2 of macroblock 406-2, etc. Note that sixteen SAD values are generated when each sub-macroblock of macroblock 406-1 is compared to each sub-macroblock of macroblock 202.

Macroblock-level SAD values can be easily generated by summing appropriate sub-macroblock SAD values. FIGS. 5B, 5C and 5D depict the macroblock-level SAD values that can be generated by using the sub-macroblock SAD values of FIG. 5A. Specifically, the values S_{AW1}, S_{BX1}, S_{CY1} and S_{DZ1} can be summed to provide the macroblock-level SAD value for macroblock 406-1, and the values S_{AW2}, S_{BX2}, S_{CY2} and S_{DZ2} can be summed to provide the macroblock-level SAD value for macroblock 406-2. In addition, the values S_{AX1}, S_{BW2}, S_{CZ1} and S_{DY2} can be summed to provide for the SAD value for the macroblock made up of sub-blocks X and Z of macroblock 406-1 and sub-blocks W and Y of macroblock 406-2. Note that some sub-macroblock SAD values are not used for calculating macroblock-level SAD values shown in FIGS. 5B, 5C and 5D.

FIGS. 5E and 5F further depict the macroblock-level SAD values according to an embodiment of the invention. In FIGS. 5E and 5F, the sub-macroblock SAD values for macroblocks 406-1, 406-2, 4064 and 406-5 are depicted. In FIG. 5E, for example, the SAD values S_{AY1}, S_{BZ1}, S_{CW4} and S_{DX4} can be combined to form a macroblock-level SAD value for a macroblock that is made up of the lower half of macroblock 406-1 (e.g., Y1 and Z1) and the upper half of macroblock 406-4 (e.g., W4 and X4). In FIG. 5F, as an other example, the SAD values S_{AZ1}, S_{BY2}, S_{CX4} and S_{DW5} can be combined to form a macroblock-level SAD value for a macroblock that is made up of the lower-right quadrant of macroblock 406-1, the lower-left quadrant of macroblock 406-2, the upper-right quadrant of macroblock 406-4 and the upper-left quadrant of macroblock 406-5.

As mentioned earlier, according to a preferred embodiment of the invention, macroblocks are retrieved and processed one macroblock at a time from left to right and row-by-row. In this embodiment, sub-macroblock SAD values corresponding to two rows of macroblocks (e.g., rows 402 and 403) are stored in a local memory of the video encoder. There is no need to store sub-macroblock SAD values for the entire frame. This is because, in the present embodiment, macroblock-level SAD values are generated as the sub-macroblock SAD values are generated. Once an entire row of macroblocks have been processed, the sub-macroblock SAD values for the immediately previous row would no longer be needed, and the memory can be reused to store sub-macroblock SAD values for the following row.

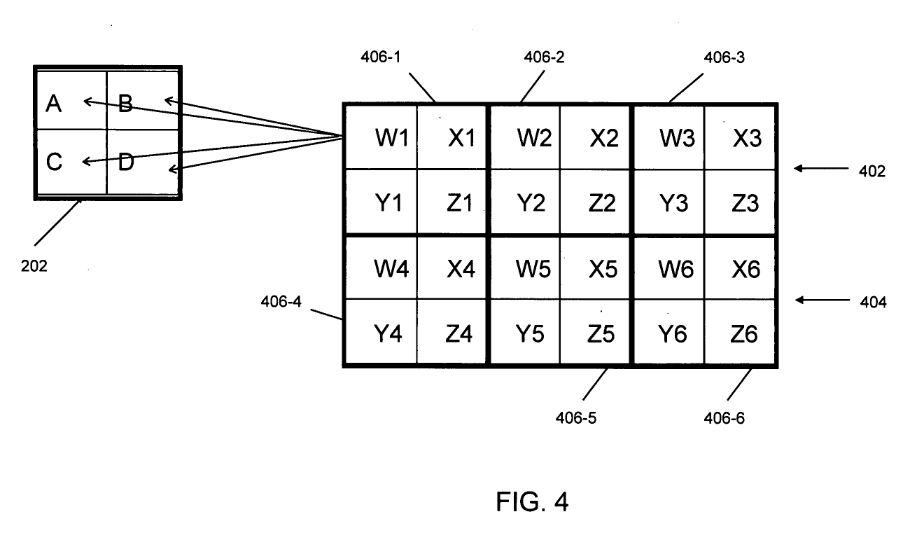

As an example, consider macroblock 406-6 in FIG. 4. As the sub-macroblock SAD values for macroblock 406-6 are generated, the system would have sufficient information for generating the macroblock-level SAD values for (1) the macroblock 406-6, (2) the macroblock that consists of Z2, Y3, X5, and W6, (3) the macroblock that consists of Y3, Z3, W6 and X6, and (4) the macroblock that consists of X5, W6, Z5 and Y6. Essentially, the same macroblock SAD values will be generated if all such macroblocks were individually retrieved and compared against current macroblock 202. Assuming macroblock 406-6 is the last macroblock of the row 403, the sub-macroblock SAD values for macroblocks 406-1, 406-2 and 406-3 would no longer be needed for the following row. Thus, the memory containing such data could be reallocated to store the sub-macroblock values for the following row.

It should also be noted that SAD values for macroblock of various sizes (e.g., 8×16) can be obtained by selectively summing the appropriate sub-macroblock SAD values. For example, SAD value for a 16×8 macroblock consisting of X4 and W5 would be obtained by summing the sub-macroblock SAD values S_{BX4} and S_{AW5}. In the preferred embodiment where sub-macroblock SAD values are kept for two consecutive rows, macroblock values for some macroblocks may not be obtained, however.

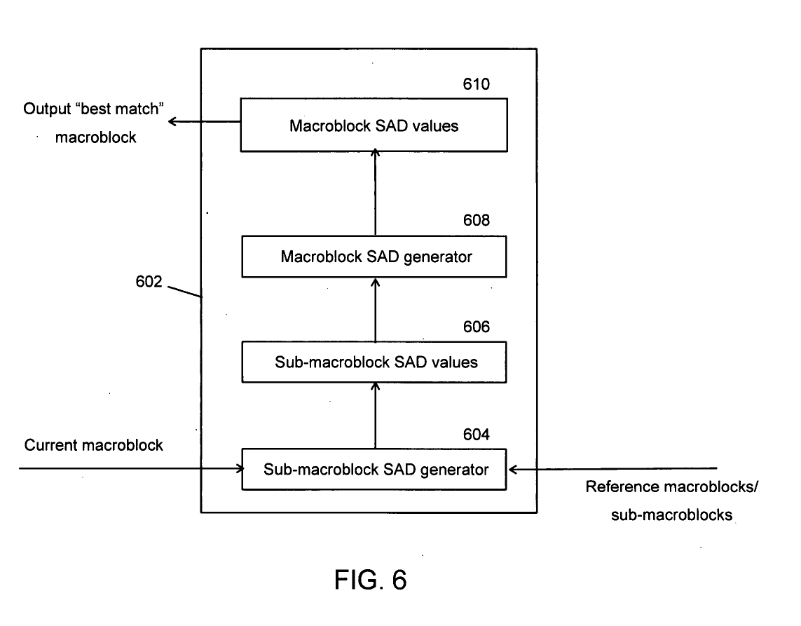

FIG. 6 depicts a block diagram for a portion of a video encoder including a macroblock calculation unit (MCU) 602 according to an embodiment of the present invention. As illustrated, MCU 602 includes a sub-macroblock SAD generator 604, which is configured to receive current macroblocks and reference macroblocks from a frame memory. According to an embodiment of the invention, the MCU 602 accomplishes motion searching by stepping the current macroblock through the macroblocks in a search area of the reference frame row-by-row with no overlap.

According to an embodiment of the invention, sub-macroblock SAD generator 604 compares a each sub-macroblock of the current macroblock against each sub-macroblock of a reference sub-macroblock to generate a set of sub-macroblock SAD values 606, such as those depicted in FIG. 5A. In one embodiment of the invention, the sub-macroblock SAD values 606 are stored in a local buffer memory or cache, as opposed to the frame memory, which is “off-chip.”

Macroblock SAD generator 608 then uses the sub-macroblock SAD values 606 to generate macroblock-level SAD values 610, which are stored in the local buffer memory. According to an embodiment of the invention, macroblock-level SAD values may be generated by selectively summing the appropriate SAD values, such as the sub-macroblock SAD values shown in FIGS. 5B to 5F. [Provide more description here.] Thereafter, the MCU 602 selects the reference macroblock having the lowest macroblock SAD value as the “best match” for encoding the current macroblock.

Various embodiments of the invention provide an advantageous method and system to access data for performing motion search. The system includes a sub-macroblock SAD generator for calculating SAD values at a sub-macroblock level, a temporary memory such as a buffer memory or cache for storing the sub-macroblock SAD values, a macroblock SAD generator for generating the macroblock-level SAD values by summing SAD values of immediately neighboring sub-macroblocks. The resulting macroblock-level SAD values may then be used for motion search. As discussed above, non-overlapping reference macroblocks are compared against the current macroblocks to produce the sub-macroblock level SAD values, which are temporarily stored and selectively combined to produce macroblock-level SAD values. In this way, access to the frame memory that stores the reference macroblocks and current macroblocks may be reduced without sacrificing the performance of the video encoder.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims. For example, while there are several references to implementation as an FPGA, alternate implementations in Application Specific Integrated Circuits (ASICs) and other types of integrated circuit devices are possible. As another example, while Sum of Absolute Difference (SAD) values are used in the described embodiments of the invention, it will be apparent to those skilled in the art having the benefit of this disclosure that other criteria may be used for searching for the “best match” macroblock.

Furthermore, throughout this specification (including the claims if present), unless the context requires otherwise, the word “comprise”, or variations such as “comprises” or “comprising”, will be understood to imply the inclusion of a stated element or group of elements but not the exclusion of any other element or group of elements. The word “include,” or variations such as “includes” or “including,” will be understood to imply the inclusion of a stated element or group of elements but not the exclusion of any other element or group of elements. Claims that do not contain the terms “means for” and “step for” are not intended to be construed under 35 U.S.C. §112, paragraph 6.

What is claimed is:

1. A method of performing motion search in a video encoder that is coupled to an external frame memory where macroblocks are stored, the method comprising:
a. retrieving a first macroblock from said frame memory;
b. calculating sub-macroblock Sum of Absolute Difference (SAD) values for sub-macroblocks of said first macroblock;
c. producing from said sub-macroblock SAD values a first SAD value for said macroblock;
d. producing from said sub-macroblock SAD values and previously stored sub-macroblock SAD values a second SAD value for a second macroblock, wherein said second macroblock comprises at least part of said first macroblock; and
e. determine a best match SAD value from a plurality of macroblock SAD values including said first and second macroblock SAD values.

2. The method of claim 1, further comprising storing said sub-macroblock SAD values.

3. The method of claim 1, wherein said first macroblock comprises four sub-macroblocks.

4. The method of claim 1, wherein said first macroblock has a same number of pixels as said second macroblock.

5. The method of claim 1, wherein said first macroblock has a different number of pixels than said second macroblock.

6. The method of claim 1, wherein said calculating comprises comparing a current macroblock to said first macroblock and generating sixteen sub-macroblock SAD values for said reference macroblock.

7. A video encoder that is coupled to an external frame memory where macroblocks are stored, comprising:
a. a sub-macroblock Sum of Absolute Difference (SAD) value generator coupled to receive a current macroblock and a reference macroblock from the frame memory and configured to generate sub-macroblock SAD values that indicate differences between a sub-macroblock of said current macroblock and each sub-macroblock of said reference macroblock;
b. an internal buffer configured to store at least the sub-macroblock SAD values;
c. a macroblock SAD value generator coupled to said internal buffer to receive said sub-macroblock SAD values and previously generated sub-macroblock SAD values, said macroblock SAD value generator further configured to generate a first macroblock SAD value for said reference macroblock and a second macroblock SAD values for a second macroblock that comprises at least part of said reference macroblock; and
d. a comparison unit to determine a best match SAD value from a plurality of macroblock SAD values including said first and second macroblock SAD values.

8. The video encoder of claim 7, wherein said first macroblock comprises four sub-macroblocks.

9. The video encoder of claim 7, wherein said first macroblock has a same number of pixels as said second macroblock.

10. The video encoder of claim 7, wherein said first macroblock has a different number of pixels than said second macroblock.

11. The video encoder of claim 7, wherein said sub-macroblock SAD value generator compares each sub-macroblock of a current macroblock to each sub-macroblock first macroblock and generates sixteen sub-macroblock SAD values for said reference macroblock.
